(19) United States
(12) Patent Application Publication
(10) Pub. No.: US 2013/0346701 A1
(43) Pub. Date: Dec. 26, 2013

(54) REPLACEMENT METHOD AND APPARATUS FOR CACHE

(71) Applicant: Huawei Technologies Co., Ltd., Shenzhen (CN)

(72) Inventor: Liren Chen, Shenzhen (CN)

(73) Assignee: Huawei Technologies Co., Ltd., Shenzhen (CN)

(21) Appl. No.: 13/923,867

(22) Filed: Jun. 21, 2013

(30) Foreign Application Priority Data
Jun. 21, 2012 (CN) 201210207136.0

(51) Int. Cl. G06F 12/12

(52) U.S. Cl. CPC G06F 12/122; G06F 12/128
USPC 711/136

(57) ABSTRACT

Embodiments of the present invention provide a data replacement method and apparatus for a Cache, and the method includes: obtaining a working state of a Cache, determining whether a case that burst traffic of data input into the Cache is excessively heavy occurs; and if the case that the burst traffic of the data is excessively heavy occurs, determining a data replacement period that is adaptive to the burst traffic of the data, so that the Cache replaces data stored in the Cache with the input data according to the data replacement period. In the embodiments of the present invention, in a manner of determining a data replacement period that is adaptive to current burst traffic of data, replacement of data stored in a Cache is delayed, occurrence of computer performance reduction is postponed, a duration of performance reduction is reduced, and furthermore a degree of performance reduction is reduced.

### CROSS-REFERENCE TO RELATED APPLICATION

This application claims priority to Chinese Patent Application No. 201210207136.0, filed on Jun. 21, 2012, which is hereby incorporated by reference in its entirety.

### TECHNICAL FIELD

The present invention relates to data processing technologies, and in particular, to a replacement method and apparatus for a cache (Cache).

### BACKGROUND

With the rapid development of computer technologies, an access speed gap between a processor and a memory is growing larger, which makes a problem of memory wall become worse, and becomes one of the most major bottlenecks that influence the performance of a computer system. The so-called memory wall refers to a phenomenon that memory performance severely limits CPU performance.

To alleviate a speed gap between a CPU and a memory, a manner of disposing a cache Cache between a CPU and a memory is widely adopted in an existing computer architecture, so that some program data or packet data is stored in the Cache, where the program data or the packet data may be repeatedly invoked. When accessing a memory, a CPU first determines whether content to be accessed is in a Cache. If the content to be accessed is in the Cache, it is referred to as a “hit”, and at this time, the CPU directly invokes the content to be accessed from the Cache; and if the content to be accessed is not in the Cache, it is referred to as a “miss”, the CPU needs to invoke the content to be accessed from the memory. An access speed of the Cache is very high, so that the utilization of the CPU is greatly improved, and further the performance of the entire computer system is also enhanced.

Data is stored in a Cache and is invoked by a CPU to perform parsing and processing operations when necessary. Generally, a speed that data is input into a Cache is far lower than a speed that a CPU processes data, so that the CPU has enough time to process data in the Cache. Therefore, when new data is input into the Cache and data replacement is required, the Cache may select, according to an instruction of the CPU, processed data as a to-be-replaced object, which is then replaced and removed from the Cache. When a case of excessively heavy data burst traffic occurs, a speed that data is stored into a Cache is higher than a processing speed of a CPU. In consideration of a capacity problem of the Cache, at this time, currently input data is regarded as data required to be accessed recently and is stored into the Cache to replace data previously stored in the Cache. In the case of a burst, a to-be-replaced selected object may still have not been processed by the CPU. If this part of data is replaced from a current level Cache to a next level Cache (some computers may be configured with a second level cache and a third level cache, and capacity of each level cache is greater than that of a previous level cache and a speed of each level cache is lower than that of a previous level cache. Herein, the previously stored data is replaced from a first level cache to a second level cache, and even a third level cache) or is replaced to a DDR (Double Data Rate, double data rate synchronous dynamic random memory). When the CPU needs to invoke this part of data, the CPU can only read the data from a next level Cache or from a DDR, which reduces a data hit rate of a current level Cache. A low data hit rate means that, during data processing, the CPU needs to read data from other places, which certainly increases time for the CPU to read data, reduces a processing speed of the CPU, thereby causing computer performance reduction.

### SUMMARY

Embodiments of the present invention provide a data replacement method and apparatus for a Cache. When a case of heavy data burst traffic occurs, by reasonably replacing data stored in a Cache, the objectives of postponing occurrence of computer performance reduction, shortening a duration of performance reduction, and reducing a degree of performance reduction.

Therefore, the embodiments of the present invention provide the following technical solutions.

A data replacement method for a Cache includes:

obtaining a working state of a Cache and determining whether a case that burst traffic of data input into the Cache is excessively heavy occurs; and

if the case that the burst traffic of the data is excessively heavy occurs, determining a data replacement period that is adaptive to the burst traffic of the data, so that the Cache replaces data stored in the Cache with the input data according to the data replacement period.

A data replacement apparatus for a Cache includes:

a working state obtaining unit, configured to obtain a working state of a Cache and determine whether a case that burst traffic of data input into the Cache is excessively heavy occurs; and

a data replacement period determining unit, configured to, if the case that the burst traffic of the data is excessively heavy occurs, determine a data replacement period that is adaptive to the burst traffic of the data, so that the Cache replaces data stored in the Cache with the input data according to the data replacement period.

With the data replacement method and apparatus for a Cache according to the embodiments of the present invention, it is determined, by obtaining a working state of a Cache, whether a case that burst traffic of data is excessively heavy occurs currently. If occurs, it indicates that a data replacement period currently adopted in the Cache cannot be adaptive to current burst traffic of data, and the data replacement period needs to be adjusted to be adaptive to the current burst traffic of the data. In the embodiments of the present invention, by using a manner of determining a proper data replacement period, replacement of data stored in the Cache is delayed, occurrence of computer performance reduction is postponed, a duration of performance reduction is shortened, and furthermore, a degree of performance reduction is reduced.

### BRIEF DESCRIPTION OF DRAWINGS

To describe the technical solutions in the embodiments of the present application or in the prior art more clearly, the following briefly introduces the accompanying drawings required for describing the embodiments or the prior art. Apparently, the accompanying drawings in the following description show merely some of the embodiments described in the present application, and persons of ordinary skill in the art may still obtain other drawings from these accompanying drawings.

FIG. 1 is a flow chart of a data replacement method for a Cache according to an embodiment of the present invention;

FIG. 2-a is a schematic diagram of a case that burst traffic of data input into a Cache is excessively heavy occurs;

FIG. 2-b is a schematic curve diagram of a performance reduction case when the number of times of reading/writing allocation request is 1;

FIG. 2-c is a schematic curve diagram of a performance reduction case when the number of times of reading/writing allocation request is infinity;

FIG. 2-d is a schematic curve diagram of a performance reduction case when the number of times of reading/writing allocation request is an appropriate value;

FIG. 3 is a schematic structural diagram of a data replacement apparatus for a Cache according to an embodiment of the present invention;

FIG. 4 is a schematic structural diagram of a first implementation manner of a working state obtaining unit according to an embodiment of the present invention; and

FIG. 5 is a schematic structural diagram of a second implementation manner of a working state obtaining unit according to an embodiment of the present invention.

### DESCRIPTION OF EMBODIMENTS

To make persons skilled in the art better understand the solutions of the present invention, the embodiments of the present invention is described in further detail in the following with reference to the accompanying drawings and implementation manners.

With a data replacement method and apparatus for a Cache according to the embodiments of the present invention, first it is determined, through a working state of a Cache, whether a case that burst traffic of data is excessively heavy occurs currently; and next, if the case that the burst traffic of the data is excessively heavy occurs, a data replacement period that is adaptive to the burst traffic of the data is determined, so that the Cache replaces data stored in the Cache according to the determined data replacement period, thereby achieving an objective of reducing a degree of computer performance reduction in the prior art.

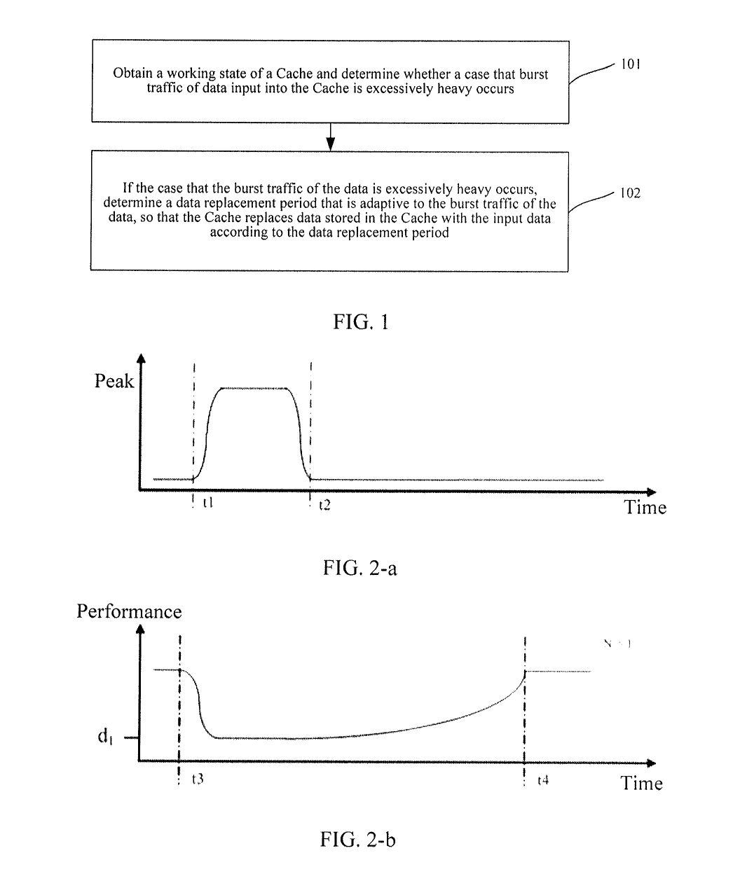

FIG. 1 is a flow chart of a data replacement method for a Cache according to an embodiment of the present invention, where the method includes:

Step 101: Obtain a working state of a Cache and determine whether a case that burst traffic of data input into the Cache is excessively heavy occurs.

In the embodiment of the present invention, the burst traffic of the data is excessively heavy, which means that the amount of data that is not processed by a CPU exceeds a preset threshold.

In an existing computer architecture, data may be stored in a Cache through a GMAC (Gigabit Media Access Control, gigabit media access control), so that the CPU performs a reading/writing operation directly on the data stored in the Cache and completes data parsing and processing, thereby achieving an objective of enhancing computer system performance.

In the embodiment of the present invention, to avoid a problem that when burst traffic of data is excessively heavy, data that is stored in a Cache but has not been invoked and processed by a CPU is replaced, thereby causing that when the CPU subsequently needs to process this part of unprocessed data that has been replaced, the CPU needs to read the data from a lower level Cache with a lower access speed or even from a DDR, which results in a problem of computer performance reduction. First, it needs to determine whether a case that burst traffic of data is excessively heavy occurs currently. If occurs, a degree of computer performance reduction is reduced according to the solution in the embodiment of the present invention, namely, the excessively heavy burst traffic is a condition of triggering the replacement method in the embodiment of the present invention; and if not occur, when data stored in the Cache needs to be replaced, an existing replacement algorithm for a Cache is adopted in real time to select a to-be-replaced object to complete a replacement operation action. The existing replacement algorithm for a Cache may include a pseudo-random replacement algorithm, a least recently used algorithm, a pseudo least recently used algorithm, and so on.

This step is a process of obtaining a working state of a Cache and determining, in real time, whether a case that burst traffic of data is excessively heavy occurs, and this step provides a certain technical basis for determining a data replacement period that is adaptive to the burst traffic of the data subsequently.

Specific manners of obtaining a working state of a Cache and determining a case that burst traffic of data is excessively heavy in this step are not described in detail herein.

Step 102: If the case that the burst traffic of the data is excessively heavy occurs, determine a data replacement period that is adaptive to the burst traffic of the data, so that the Cache replaces data stored in the Cache with the input data according to the data replacement period.

In the prior art, whether the GMAC stores data into the Cache normally (herein storing data into the Cache normally includes: a case that burst traffic does not occur, and a case that burst traffic occurs but the amount of data that is not processed by the CPU does not exceed a preset threshold) or stores data into the Cache in a case that burst traffic is excessively heavy, the Cache operates in the same manner, namely, when data needs to be replaced, the Cache immediately selects a to-be-replaced object from the stored data, and replaces the to-be-replaced object to a lower level Cache or a DDR, and in this way, the data that is not processed by the CPU may also be replaced and removed from a current level Cache, thereby causing that continuous data misses occur in the Cache, and further causing computer performance reduction.

Compared with the prior art, in the embodiment of the present invention, it is first determined whether a case that burst traffic of data is excessively heavy occurs currently, and distinctive processing is performed for two cases of storing data into the Cache normally and of storing data into the Cache in the case that burst traffic is excessively heavy. If data is stored into the Cache normally, when data needs to be replaced, replacement is performed immediately: and if data is stored in a burst case, a data replacement period that is adaptive to the current burst case is determined. A to-be-replaced object is selected from the stored data according to the determined data replacement period to perform data replacement, which can appropriately delay the replacement of the stored data in the Cache, and reserve a period of time for the CPU to process this part of data, so that the CPU processes this part of data as much as possible within the period of time to decrease the amount of unprocessed data among data that is replaced and removed from a current level Cache. By decreasing the amount of unprocessed data that is replaced and removed from the current level Cache as much as possible, the possibility that the CPU reads data from a lower level Cache or a DDR is reduced, thereby avoiding continuous data misses and ensuring a data hit rate of the current level Cache, and therefore a degree of computer performance reduction is also reduced.

It should be noted that, in the embodiment of the present invention, an existing replacement algorithm for a Cache such as a pseudo-random replacement algorithm, a least recently used algorithm, or a pseudo least recently used algorithm may also be used to select a to-be-replaced object.

The specific manners of obtaining a working state of a Cache and determining a case that burst traffic of data is excessively heavy in step 101 are explained and described in the following.

When the GMAC stores the data into the Cache normally, the CPU has enough time to process the data stored in the Cache, and a case that data that has not been processed by the CPU is replaced and removed from a current level Cache does not occur. Therefore, the embodiment of the present invention is based on a practical case of unprocessed data in the Cache, and when data needs to be stored into the Cache, it is determine, according to the following two specific implementation manners, whether excessively heavy burst traffic occurs.

A first manner is to directly determine excessively heavy burst traffic by using the amount of unprocessed data in the Cache. In this manner, obtaining a working state of a Cache is a process of obtaining the amount P of unprocessed data among data stored in the Cache. Correspondingly, determining whether a case that burst traffic is excessively heavy occurs is determining whether the amount P of unprocessed data is greater than a preset value, if the amount P of unprocessed data is greater than the preset value, it is determined that the case that burst traffic of data is excessively heavy occurs; and otherwise, it is determined that the case that burst traffic of data is excessively heavy does not occur. The CPU can process this part of unprocessed data normally, so that performance reduction does not occur.

By taking a Cache with 8 Ways (namely, after the Cache is grouped, each group includes 8 lines) as an example, if the preset value is 3, when it is found that 2 Ways in the Cache are filled with unread data (namely, P=2), it is determined that the case that burst traffic of data is excessively heavy does not occur; and when it is found that 4 or even 8 Ways in the Cache are filled with unread data, it is determined that the case that burst traffic of data is excessively heavy occurs.

A second manner is to determine excessively heavy burst traffic indirectly by using a speed of inputting data into the Cache and a processing speed of the CPU. In this manner, obtaining a working state of a Cache is a process of obtaining the amount N of data that is input into the Cache within a unit time and the amount M of data that is processed by the CPU within a unit time. Correspondingly, determining whether a case that burst traffic is excessively heavy occurs is determining whether N is greater than M. If N is greater than M, it indicates that the processing speed of the CPU is lower than the speed of inputting data into the Cache, so that unprocessed data in the Cache is very likely to be replaced with newly input data and removed from a current level Cache, and therefore, it is determined that the case that burst traffic of data is excessively heavy occurs; and if N is not greater than M, it is determined that the case that burst traffic of data is excessively heavy does not occur.

For example, if the amount of data that is input into the Cache within a unit time N=10, and the amount of data that is processed by the CPU within a unit time M=4, it is determined that the case that burst traffic of data is excessively heavy occurs.

To sum up, in the embodiment of the present invention, the meaning of excessively heavy burst traffic of data is defined from two angles: One angle is the total amount of data that is not processed by a CPU in a Cache, which is a most intuitive manner to reflect excessively heavy burst traffic; and the other angle is the amount of dynamic data entering and leaving a Cache within a unit time, which is a most accurate manner to reflect excessively heavy burst traffic.

For the foregoing two specific manners of achieving objectives of obtaining a working state of a Cache and determining a case that burst traffic of data is excessively heavy in step 101, corresponding different manners of setting a data replacement period are also provided in step 102, which are specifically as follows:

(1) If it is determined, by obtaining the amount P of unprocessed data among data stored in the Cache in step 101 and in a manner of determining that P is greater than a preset value, that the case that burst traffic of data is excessively heavy occurs currently, a data replacement period that is adaptive to the current burst traffic of data is set by using the obtained value of P. A specific formula is as follows.

The data replacement period T=K₁*P, where K₁ is a positive integer. That is to say, the data replacement period T is directly proportional to P: the greater the amount P of unprocessed data is, the longer the data replacement period T is; and otherwise, the shorter the data replacement period T is.

Still by taking a Cache with 8 Ways as an example, if 4 Ways in the Cache are filled with unread data, the data replacement period may be set as T=3 ns. That is to say, data in the Ways is replaced with data newly entering the Cache once every 3 ns. If 8 Ways in the Cache are filled with unread data, the data replacement period may be set as T=6 ns. That is to say, data in the Ways is replaced with data newly entering the Cache once every 6 ns.

(2) If it is determined, by obtaining the amount N of data that is input into the Cache within a unit time and the amount M of data that is processed by the CPU within a unit time in step 101 and in a manner of determining that N is greater than M, that the case that burst traffic of data is excessively heavy occurs currently, a data replacement period that is adaptive to the current burst traffic of data is set by using a ratio of N to M. A specific formula is as follows.

The data replacement period T=K₂*N/M, where K₂ is a positive integer. That is to say, the data replacement period T is directly proportional to N, and inversely proportional to M. The ratio of N/M reflects the impact strength of the current burst traffic of data on the Cache, a greater ratio indicates greater impact strength, and a longer data replacement period T needs to be set. It may be specifically represented as that: In a case of the same value of M, if a value of the amount N of data that is input into the Cache within a unit time is greater, the data replacement period T is longer; while in a case of the same value of N, if the amount M of data that is processed by the CPU within a unit time is greater, the data replacement period T is shorter.

For example, when N/M=2 to 4, the data replacement period may be set as T=6 ns. That is to say, data in the Cache is replaced once every 6 ns. When N/M=4 to 8, the data replacement period may be set as T=8 ns. That is to say, data in the Cache is replaced once every 8 ns.

It should be noted that, the data replacement period Tin the embodiment of the present invention may be represented as a fixed replacement duration that is based on a work clock of a Cache, namely, the data replacement period T includes L work clocks, and replacement is performed on data in the Cache once every L work clocks. The work clock of the Cache is fixed, and therefore the data replacement period T is also a fixed duration. In addition, the data replacement period T may also be represented as an unfixed duration that is based on the number of times of reading/writing allocation request of a CPU, namely, the data replacement period T includes I times of reading/writing allocation request, and replacement is performed on data in the Cache once every I times of reading/writing allocation request. Intervals of every two times of reading/writing allocation request may be different, and therefore the data replacement period T is also an unfixed duration. Although data replacement that is performed by adopting a manner of an unfixed duration may make an interval of replacing data each time different, this manner is performed for a processing action of a practical reading/writing operation of the CPU, thereby ensuring more accurate and targeted replacement of data in the Cache.

The foregoing examples taken to introduce a manner of setting a data replacement period are all fixed replacement durations that are based on a work clock of a Cache. For example, if a work clock of a Cache is 1 ns, in the example that 4 Ways in the Cache are filled with unread data and the data replacement period is set as T=3 ns, each data replacement period T includes 3 work clocks. That is to say, data replacement is performed in the Cache once every 3 work clocks. When N/M=2 to 4, in the example that the data replacement period is set as T=6 ns, it indicates that each data replacement period T includes 6 work clocks. That is to say, data replacement is performed in the Cache once every 6 work clocks.

In addition, it should be noted that, the data replacement period in the embodiment of the present invention is a dynamic period, different cases that burst traffic of data is excessively heavy correspond to different periods, and each data replacement period is only limited to its corresponding data burst case. For example, a data replacement period corresponding to a certain data burst case is T₁=3 work clocks. After processing of data in a current burst case is completed, if the data is normally stored into the Cache, a data replacement period T₂=1 work clock. If a case that burst traffic of data is excessively heavy occurs for another time, a replacement period is set for the burst case again, for example, T₃=5 work clocks.

By taking an example that the data replacement period T includes different number of times of reading/writing allocation request, a degree of computer performance reduction and a start/stop moment and a duration of performance reduction are introduced in the following.

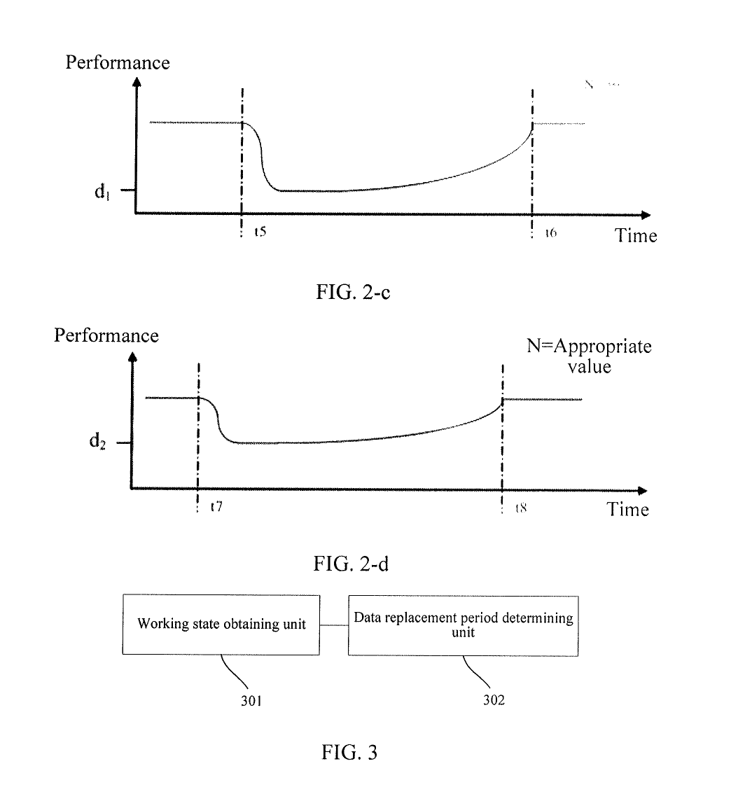

Referring to FIG. 2-a, it indicates that a case that burst traffic of data input into a Cache by a GMAC within a time period t₁-t₂ is excessively heavy occurs, FIG. 2-b, FIG. 2-c, and FIG. 2-d show corresponding degrees of computer performance reduction, start/stop moments of performance reduction, and durations of performance reduction when different values are taken for the number of times I of reading/writing allocation request in the case that burst traffic is excessively heavy, as shown in FIG. 2-a, occurs.

(1) FIG. 2-b is a schematic diagram of a performance reduction case when the number of times of reading/writing allocation request I₁=1. It indicates that data replacement is performed once every time of reading/writing allocation request, which is a method of performing data replacement when a case that burst traffic of data is excessively heavy occurs in the prior art, a degree of performance reduction is d₁ and a duration of performance reduction is t₃-t₄.

(2) FIG. 2-c is a schematic diagram of a performance reduction case when the number of times of reading/writing allocation request I₂=infinity. It indicates that data stored in a Cache is not replaced, and instead, data input by a GMAC is all stored in a lower level Cache or a DDR. It can be seen from the figure that a degree of performance reduction is not reduced and is still d₁, but time that performance reduction occurs is postponed from a moment t₃ to a moment t₅. For a moment that performance reduction ends, t₆ may be the same as t₄, or may be later than t₄. That is to say, a duration of performance reduction when I₂=infinity is not shorter than a duration of performance reduction when I₁=1, and specific reasons are as follows.

In the case of I₂=infinity, external input data is all stored in a lower level Cache or a DDR, so that at this time, a duration of computer performance reduction is time required for the CPU to process all the input data stored in the lower level Cache or the DDR. In the case of I₁=1, when external input data is replaced to the Cache, a to-be-replaced object selected by the Cache may be data that is processed by the CPU, and at this time, the amount of unprocessed data stored in the lower level Cache or the DDR is less than the amount of the external input data. Therefore, for the case of I₂=infinity, a phenomenon of performance reduction in the case of I₁=1 ends in advance, and a duration of performance reduction is also shorter. Definitely, an extreme case may also occur. That is, a to-be-replaced object selected by a Cache each time is data that is not processed by a CPU, and then in both the case of I₁=1 and the case of I₂=infinity, the same amount of data needs to be processed by the CPU, and correspondingly, durations of performance reduction are also the same.

(3) FIG. 2-d is a schematic diagram of a performance reduction case when the number of times of reading/writing allocation request I₃=an appropriate value. For example, I₃=3, it indicates that data replacement is performed once every 3 times of reading/writing allocation request. It can be seen from the figure that when I₃=an appropriate value, a degree of performance reduction is obviously reduced to d₂. In addition, occurrence of performance reduction is also postponed from a moment t₃ to a moment t₇ (it should be noted that, t₇<t₅, in a case of I₂=infinity, data stored in a Cache is not replaced, performance reduction occurs after a CPU finishes processing the data stored in the Cache, and in the case of I₃=an appropriate value, the data stored in the Cache is replaced according to a data replacement period, and therefore a part of the data is replaced and removed from a current level Cache, so that when processing the part of the replaced and removed data, the CPU needs to read the data from a lower level Cache or a DDR, thereby causing that performance reduction occurs in advance), a moment t₈ that performance reduction ends is earlier than t₄. That is to say, a duration of performance reduction in the case of I₃=an appropriate value is shorter than a duration of performance reduction in the case of I₁=1, and specific reasons are as follows:

I₁=1 indicates that data replacement is performed in a Cache once every time of reading/writing allocation request. A speed that a CPU processes data is less than a speed that data enters the Cache, and therefore when a to-be-replaced object is selected, a case that a lot of unprocessed data is replaced as the to-be-replaced object and removed from a current level Cache occurs inevitably. In the case of I₃=an appropriate value, a period of time is reserved for the CPU to process data that is stored in the Cache and has not been processed, thereby greatly reducing the possibility that unprocessed data is used as the to-be-replaced object. Compared with the case of I₁=1, in the case of I₃=an appropriate value, the amount of data that needs to be read and processed by the CPU from a lower level Cache or a DDR is smaller, and therefore a duration of performance reduction is also shorter.

It can be known from FIG. 2-b, FIG. 2-c, and FIG. 2-d, in the embodiment of the present invention that, by setting a data replacement period that is adaptive to burst traffic of data, a degree of computer performance reduction can be reduced, and at the same time, occurrence of performance reduction can be postponed and a duration of performance reduction can be shortened.

It should be noted that, the data in the embodiment of the present invention may be program data or packet data. Generally, a case that burst traffic of program data is excessively heavy rarely occurs, and therefore the embodiment of the present invention is mainly designed for packet data. Before adjustment of a data replacement period by adopting the method in the embodiment of the present invention, the type of data input into a Cache may be determined first. In the case of program data, according to the prior art, data stored in a Cache is replaced in real time when replacement is required (data to be replaced may be program data, and may also be packet data); and in the case of packet data, a data replacement period that is adaptive to burst traffic is set by adopting the method provided in the embodiment of the present invention, and data stored in the Cache is replaced according to the set data replacement period. Definitely, for a program packet, by setting a data replacement period by adopting the method in the embodiment of the present invention, computer performance can be better enhanced.

Correspondingly, an embodiment of the present invention further provides a data replacement apparatus for a Cache. FIG. 3 is a schematic structural diagram of the apparatus.

In the embodiment, the apparatus includes;

a working state obtaining unit 301, configured to obtain a working state of a Cache and determine whether a case that burst traffic of data input into the Cache is excessively heavy occurs; and

a data replacement period determining unit 302, configured to, if the case that the burst traffic of the data is excessively heavy occurs, determine a data replacement period that is adaptive to the burst traffic of the data, so that the Cache replaces data stored in the Cache with the input data according to the data replacement period.

In the embodiment of the present invention, it is first determined, through a working state of a Cache, whether a case that burst traffic of data is excessively heavy occurs currently, so as to perform distinctive processing on two cases of storing data into the Cache normally and of storing data into the Cache in the case of excessively heavy burst traffic. Next, if the case that the burst traffic of the data is excessively heavy occurs, a data replacement period that is adaptive to the current burst traffic of the data is determined, so that the Cache replaces data stored in the Cache according to the determined data replacement period, and therefore replacement of data stored in the Cache is delayed, occurrence of performance reduction is postponed, a duration of performance reduction is shortened, and furthermore, a degree of performance reduction is reduced.

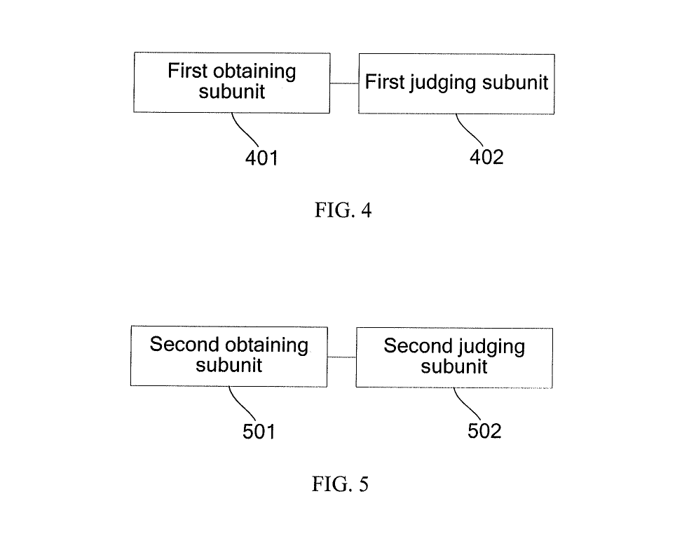

FIG. 4 is a schematic structural diagram of a first implementation manner of a working state obtaining unit, which includes:

a first obtaining subunit 401, configured to obtain the amount P of unprocessed data among data stored in a Cache; and

a first judging subunit 402, configured to determine whether P is greater than a preset value, and if P is greater than the preset value, determine that a case that burst traffic of data is excessively heavy occurs.

When the working state obtaining unit determines, in a manner that the amount P of unprocessed data is greater than the preset value, that the case that the burst traffic of the data is excessively heavy occurs, correspondingly, the data replacement period determining unit sets the data replacement period by using P. A specific formula is: the data replacement period T=K₁*P, where K₁ is a positive integer.

By taking a Cache with 8 Ways as an example, if the preset value is 3, when it is found that 4 Ways in the Cache are filled with unread data (namely, P=4), it is determined that the case that the burst traffic of the data is excessively heavy occurs. At this time, the data replacement period may be set as T=3 ns, so that the Cache performs data replacement once every 3 ns according to the set period.

It should be noted that, the length of the data replacement period depends on the amount P of unprocessed data in the Cache. The greater the amount P of unprocessed data is, the longer the data replacement period T is; and otherwise, the shorter the data replacement period T is.

FIG. 5 is a schematic structural diagram of a second implementation manner of a working state obtaining unit, which includes:

a second obtaining subunit 501, configured to obtain the amount N of data that is input into a Cache within a unit time and the amount M of data that is processed by a CPU within a unit time; and

a second judging subunit 502, configured to determine whether N is greater than M, and if N is greater than M, determine that a case that burst traffic of data is excessively heavy occurs.

When the working state obtaining unit determines, in a manner that the amount N of data that is input into the Cache within a unit time is greater than the amount M of data that is processed by the CPU within a unit time, that the case that the burst traffic of the data is excessively heavy occurs, correspondingly, the data replacement period determining unit sets the data replacement period by using a ratio of N to M. A specific formula is: the data replacement period T=K₂*N/M, where K₂ is a positive integer.

It should be noted that, the data replacement period T is directly proportional to N, inversely proportional to M, and directly proportional to A/B. The ratio of N/M reflects the impact strength of the current data burst traffic on the Cache. A greater ratio indicates greater impact strength, and a longer data replacement period T needs to be set. It may be specifically represented as that: In a case of the same value of M, if a value of the amount N of data that is input into the Cache within a unit time is greater, the data replacement period T is longer; while in a case of the same value of N, if the amount M of data that is processed by the CPU within a unit time is greater, the data replacement period T is shorter.

For example, when N/M=2 to 4, the data replacement period may be set as T=6 ns. That is to say, data in the Cache is replaced once every 6 ns. When N/M=4 to 8, the data replacement period may be set as T=8 ns. That is to say, data in the Cache is replaced once every 8 ns.

The data replacement period may be represented as a fixed replacement duration that is based on a work clock of a Cache, and may also be represented as an unfixed duration that is based on the number of times of reading/writing allocation request of a CPU. For a manner of an unfixed duration, although an interval of replacing data is different each time, this manner is performed for a processing action of a practical reading/writing operation of the CPU, thereby ensuring accurate and targeted replacement of data in the Cache.

To facilitate understanding, the foregoing listed examples for introducing the data replacement period determining unit are all described for a fixed replacement duration when a work clock of a Cache is 1 ns. In a case of the data replacement period T=3 ns, data replacement is performed in the Cache once every 3 work clocks; and in a case of the data replacement period T=6 ns, data replacement is performed in the Cache once every 6 work clocks. Compared with the case of T=3 ns, a longer time is reserved for the CPU in the case of T=6 ns.

By using the technical solutions provided by the data replacement apparatus for a Cache in the embodiment of the present invention, and according to a practical case of burst traffic of data, a data replacement period that is adaptive to the practical case is set, so as to appropriately delay replacement of data stored in the Cache, reserve a period of time for a CPU to process this part of data, and enable the CPU to process this part of data as much as possible within the period of time, thereby decreasing the amount of unprocessed data among data that is replaced and removed from a current level Cache. By decreasing the amount of unprocessed data that is replaced and removed from the current level Cache as much as possible, the possibility that the CPU reads data from a lower level Cache or a DDR can be reduced, thereby avoiding continuous data misses and ensuring a data hit rate of the current level Cache, and therefore a degree of computer performance reduction is also reduced. At the same time, beneficial effects such as postponing occurrence of performance reduction and shortening a duration of performance reduction may also be achieved.

The solutions of the present invention may be described in the general context of a computer executable instruction executed by a computer, for example, a program unit. Generally, the program unit includes a routine, program, object, component, and data structure for executing a particular task or implementing a particular abstract data type. The solutions of the present invention may also be carried out in distributed computing environments. In these distributed computing environments, a remote processing device that is connected through a communication network executes a task. In a distributed computing environment, the program unit may be located in local and remote computer storage mediums that include a storage device.

The embodiments in the specification are all described in a progressive manner, mutual reference may be made to the same part or similar parts between the embodiments, and each embodiment focuses on the description of a difference from other embodiments. Particularly, a system embodiment is basically similar to a method embodiment, and therefore the description is simple, and reference may be made to the part of description in the method embodiment. The foregoing described system embodiment is merely exemplary. The units described as separate parts may or may not be physically separate, and the parts displayed as units may or may not be physical units, may be located at one position, or may be distributed on multiple network units. A part or all of modules may be selected according to a practical need to achieve the objectives of the solutions of the embodiments, which may be understood and implemented by persons of ordinary skill in the art without creative efforts.

The embodiments of the present invention are introduced in detail in the foregoing. Specific implementation manners are used for describing the present invention in this specification. The foregoing descriptions of the embodiments are merely for helping understand the method and device of the present invention. At the same time, persons of ordinary skill in the art may make modifications to the specific implementation manners and application scope according to the ideas of the present invention. In conclusion, the content of the specification shall not be construed as a limitation to the present invention.

What is claimed is:

1. A data replacement method for a Cache, comprising:
obtaining a working state of a Cache and determining whether a case that burst traffic of data input into the Cache is excessively heavy occurs; and
if the case that the burst traffic of the data is excessively heavy occurs, determining a data replacement period that is adaptive to the burst traffic of the data, so that the Cache replaces data stored in the Cache with the input data according to the data replacement period.

2. The method according to claim 1, wherein the obtaining a working state of a Cache comprises:
obtaining the amount P of unprocessed data among the data stored in the Cache;
the determining whether a case that burst traffic of data input into the Cache is excessively heavy occurs comprises:
determining whether P is greater than a preset value, and if P is greater than the preset value,
determining that the case that the burst traffic of the data is excessively heavy occurs; and
the determining a data replacement period that is adaptive to the burst traffic of the data comprises:
setting the data replacement period by using P.

3. The method according to claim 2, wherein the setting the data replacement period by using P comprises:
the data replacement period T=K₁*P, wherein K₁ is a positive integer.

4. The method according to claim 1, wherein the obtaining a working state of a Cache comprises:
obtaining the amount N of data that is input into the Cache within a unit time and the amount M of data that is processed by a CPU within a unit time;
the determining whether a case that burst traffic of data input into the Cache is excessively heavy occurs comprises:
determining whether N is greater than M, and if N is greater than M, determining that the case that the burst traffic of the data is excessively heavy occurs; and
the determining a data replacement period that is adaptive to the burst traffic of the data comprises:
setting the data replacement period by using a ratio of N to M.

5. The method according to claim 4, wherein the setting the data replacement period by using a ratio of N to M comprises:
the data replacement period T=K₂*N/M, wherein K₂ is a positive integer.

6. The method according to claim 5, wherein:
the data replacement period is a fixed replacement duration that is based on a work clock of the Cache; or,
the data replacement period is an unfixed replacement duration that is based on the number of times of reading/writing allocation request of the CPU.

7. The method according to claim 5, wherein the data is program data or packet data.

8. A data replacement apparatus for a Cache, comprising:
a working state obtaining unit, configured to obtain a working state of a Cache and determine whether a case that burst traffic of data input into the Cache is excessively heavy occurs; and
a data replacement period determining unit, configured to, if the case that the burst traffic of the data is excessively heavy occurs, determine a data replacement period that is adaptive to the burst traffic of the data, so that the Cache replaces data stored in the Cache with the input data according to the data replacement period.

9. The apparatus according to claim 8, wherein the working state obtaining unit comprises:
a first obtaining subunit, configured to obtain the amount P of unprocessed data among the data stored in the Cache;
a first judging subunit, configured to determine whether P is greater than a preset value, and if P is greater than the preset value, determine that the case that the burst traffic of the data is excessively heavy occurs; and
the data replacement period determining unit is specifically configured to, if the case that the burst traffic of the data is excessively heavy occurs, set the data replacement period by using P.

10. The apparatus according to claim 9, wherein the data replacement period determining unit sets the data replacement period specifically according to the following formula:
the data replacement period T=K₁*P, wherein K₁ is a positive integer.

11. The apparatus according to claim 8, wherein the working state obtaining unit comprises:
a second obtaining subunit, configured to obtain the amount N of data that is input into the Cache within a unit time and the amount M of data that is processed by a CPU within a unit time;
a second judging subunit, configured to determine whether N is greater than M, and if N is greater than M, determine that the case that the burst traffic of the data is excessively heavy occurs; and
the data replacement period determining unit is specifically configured to, if the case that the burst traffic of the data is excessively heavy occurs, set the data replacement period by using a ratio of N to M.

12. The apparatus according to claim 11, wherein the data replacement period determining unit sets the data replacement period specifically according to the following formula:
the data replacement period T=K₂*N/M, wherein K₂ is a positive integer.
